(19) United States
(12) Patent Application Publication
(10) Pub. No.: US 2025/0218010 A1
(43) Pub. Date: Jul. 3, 2025

(54) ACCELERATOR FOR PROCESSING POINT CLOUD DEEP NEURAL NETWORK AND OPERATION METHOD THEREOF

(71) Applicant: SEOUL NATIONAL UNIVERSITY R&DB FOUNDATION, Seoul (KR)

(72) Inventors: Jae-Joon KIM, Seoul (KR); Hyunsung YOON, Seoul (KR)

(21) Appl. No.: 18/984,566

(22) Filed: Dec. 17, 2024

(30) Foreign Application Priority Data
Dec. 27, 2023 (KR) 10-2023-0192507
Apr. 19, 2024 (KR) 10-2024-0052502

(51) Int. Cl. G06T 7/50

(52) U.S. Cl. CPC G06T 7/50; G06T 2207/10028; G06T 2207/20084

(57) ABSTRACT

An accelerator for processing a point cloud deep neural network according to an aspect of the present specification includes at least one distance calculator configured to calculate a distance between two points different from each other, wherein the distance calculator includes a first calculation unit, a second calculation unit, and a third calculation unit, and the first calculation unit, the second calculation unit, and the third calculation unit are driven serially to calculate distances on three axes between the two points in a first operation mode, and are driven in parallel to respectively calculate the distances between different pairs of points, in a second operation mode.

### CROSS-REFERENCE TO RELATED APPLICATION

This application claims the benefit under 35 USC 119(a) of Korean Patent Application Nos. 10-2024-0052502 filed on Apr. 19, 2024 and 10-2023-0192507 filed on Dec. 27, 2023 in the Korean Intellectual Property Office, the entire disclosures of which are incorporated herein by reference for all purposes.

### BACKGROUND

### 1. Field

The present disclosure relates to an accelerator for processing a point cloud deep neural network and an operating method thereof.

### 2. Description of the Related Art

A point cloud is a set of three-dimensional points collected mainly through a Lidar sensor, an RGB-D sensor, or the like and is a data format that stores three dimensional (3D) data through a set of points consisting of three coordinates of x, y, and z and separate features added as needed.

Respective points are stored in a random order without a specific order, and there is a problem that the existing two-dimensional (2D) image processing technique may not be applied due to the randomness when processing a point cloud.

PointNet and PointNet++ are known as artificial neural networks for processing the point clouds. In particular, the PointNet++ is developed to be able to extract local features like a method for processing 2D images and includes sampling and grouping as essential processes for extracting the local features.

However, since the sampling and grouping processes require a considerable amount of calculations, a new technology that may accelerate the calculations is required.

Accordingly, the present disclosure proposes a new accelerator that may minimize calculations required for the sampling and grouping processes and accelerate calculation speeds by using one-dimensional coordinate system information for some calculations instead of utilizing all types of 3D information of points.

Prior patent document related to this includes Korean Patent No. 10-2541463 (Invention title: APPARATUS FOR ACCELERATING GRAPH CONVOLUTION NEURAL NETWORK FOR SEMANTIC SEGMENTATION OF 3D POINT CLOUD, AND METHOD FOR SEMANTIC SEGMENTATION OF 3D POINT CLOUD USING THE SAME).

### SUMMARY

The present disclosure provides an accelerator, which may increase a calculation speed in a process of processing a point cloud, and an operating method of the accelerator.

However, technical problems to be achieved by the present embodiments are not limited to the technical problems described above, and there may be other technical problems.

According to an aspect of the present disclosure, an accelerator for processing a point cloud deep neural network includes at least one distance calculator configured to calculate a distance between two points different from each other, wherein the distance calculator includes a first calculation unit, a second calculation unit, and a third calculation unit, and the first calculation unit, the second calculation unit, and the third calculation unit are driven serially to calculate distances on three axes between the two points in a first operation mode, and are driven in parallel to respectively calculate the distances between different pairs of points, in a second operation mode.

According to another aspect of the present disclosure, an operating method of an accelerator for processing a point cloud deep neural network includes calculating distances on three axes between the two points by serially driving a first calculation unit, a second calculation unit, and a third calculation unit for calculating distances between two points in a first operation mode; and respectively calculating the distances between different pairs of points by driving in parallel the first calculation unit, the second calculation unit, and the third calculation unit in a second operation mode.

According to the present disclosure, a process of processing operations of the point cloud deep neural network may be simplified. In particular, in a process of calculating a distance between two points on three axes, calculations for distances on some axes may be omitted, and thus, an operation speed may be increased. In addition, when calculations for distances on are omitted, coordinates for corresponding points do not need to be read from a memory device, and thus, the energy consumed in a memory reading process may be reduced. In addition, the present disclosure may increase an effect of simplification of calculation as the number of points increases.

### BRIEF DESCRIPTION OF THE DRAWINGS

FIGS. 1, 2, and 3 are diagrams illustrating sampling and grouping processes performed by a general point cloud deep neural network.

FIG. 4 illustrates a structure of an accelerator for processing a point cloud deep neural network according to an embodiment of the present disclosure.

FIG. 5 illustrates a specific configuration of a distance calculator according to an embodiment of the present disclosure.

FIG. 6 is a diagram illustrating an internal configuration of a sorter according to an embodiment of the present disclosure.

FIG. 7 is a diagram illustrating an internal configuration of a maximum value determiner according to an embodiment of the present disclosure.

FIG. 8 illustrates a farthest point sampling process according to an embodiment of the present disclosure.

FIG. 9 illustrates a ball query process according to an embodiment of the present disclosure.

FIG. 10 illustrates an interpolation process according to an embodiment of the present disclosure.

FIG. 11 is a flowchart illustrating an operating method of an accelerator, according to an embodiment of the present disclosure.

FIG. 12 is a flowchart illustrating a specific process of a second operation mode among operating methods of an accelerator, according to an embodiment of the present disclosure.

### DETAILED DESCRIPTION

Hereinafter, embodiments of the present disclosure will be described in detail with reference to the attached drawings such that those skilled in the art to which the present disclosure belongs may easily practice the present disclosure. However, the present disclosure may be implemented in various different forms and is not limited to the embodiments described herein. In addition, in order to clearly describe the present disclosure in the drawings, parts that are not related to the description are omitted, and similar components are given similar reference numerals throughout the specification.

In the entire specification of the present disclosure, when a component is described to be “connected” to another component, this includes not only a case where the component is “directly connected” to another component but also a case where the component is “electrically connected” to another component with another element therebetween. In addition, when it is described that a portion “includes” a certain component, this means that the portion may further include another component without excluding another component unless otherwise stated.

In the present disclosure, a “portion” includes a unit realized by hardware, a unit realized by software, and a unit realized by using both. In addition, one unit may be realized by using two or more pieces of hardware, and two or more units may be realized by using one piece of hardware. Meanwhile, a “˜ portion” is not limited to software or hardware, and a “˜ portion” may be configured to be included in an addressable storage medium or may be configured to reproduce one or more processors. Therefore, in one example, “˜ portion” refers to components, such as software components, object-oriented software components, class components, and task components, and includes processes, functions, properties, and procedures, subroutines, segments of program code, drivers, firmware, microcode, circuits, data, databases, data structures, tables, arrays, and variables. The functions provided within the components and “portions” may be combined into a smaller number of components and “portions” or may be further separated into additional components and “portions”. Additionally, components and “portions” may be implemented to regenerate one or more central processing units (CPUs) included in a device or security multimedia card.

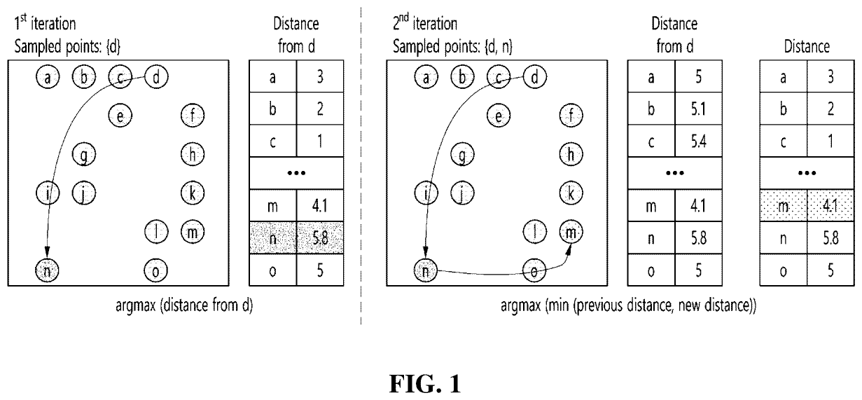

FIGS. 1, 2, and 3 are diagrams illustrating sampling and grouping processes that are performed in a typical point cloud deep neural network.

For reference, a PointNet++ model having a PointNet++ structure includes main components of set abstraction and feature propagation. In this case, the set abstraction performs sampling, grouping, MLP, and reduction processes, and the feature propagation performs interpolation, concatenation, and so on. During feature propagation, interpolation may be performed at a skip-connected point by identifying the nearest neighbor of a sampled input point among sampled points.

FIG. 1 illustrates the farthest point sampling (FPS) used as a sampling algorithm of PointNet++.

First, the second point n, which is a point argmax (a distance from d) that is the farthest from a first point d randomly selected among multiple points, is selected as the sampling target in the first round. In this case, all distances from the first point to other points are calculated, and the point with the longest distance among all distances is sampled as the second point. In addition, although FIG. 1 is illustrated in two-dimensionally for the sake of convenience of description, a next sampling target is selected based on the three-dimensional Euclidean distance between respective points.

In addition, in the second round, in order to sample the third point, a distance between the remaining candidate points and the second point is compared with a distance between the first point calculated to determine the second point in the first round and the candidate point, and a candidate point having the maximum value among the two smaller distances (argmax (min (previous distance, new distance))) is selected as a sampling target for the third point. To this end, a value for a distance between each candidate point and the first point calculated in the first round is reused as the previous distance. In addition, a new distance between the candidate point and the second point is newly calculated and compared with the previous distance. For example, as illustrated in the table of FIG. 1, a distance between a point a and the first point d is 3, and a distance between the point a and the second point n is 5, and accordingly, the smaller value 3 of the two values is maintained. Similarly, a distance between a point b and the first point d is 2, and a distance between the point b and the second point n is 5.1, and accordingly, the smaller value 2 is maintained. In this way, the smaller values of the previous distance and the new distance are maintained, and a point m with the largest distance is sampled as the third point.

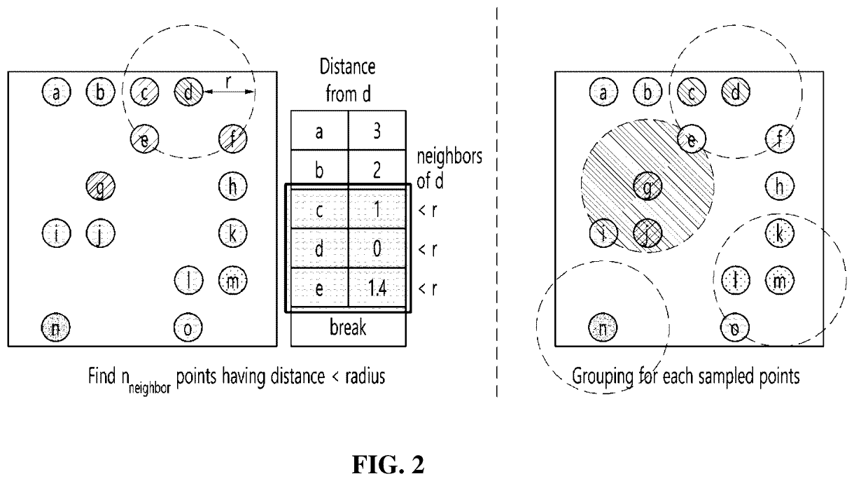

FIG. 2 illustrates a ball query algorithm used as a grouping algorithm of PointNet++. The Ball Query algorithm is an algorithm that groups neighboring points for points for which sampling is completed. Points located within a reference distance r from the first point d are considered to be neighbors, and the grouping may be repeated until a preset number of neighbors are grouped. By repeating the process, points located within a reference distance form a group.

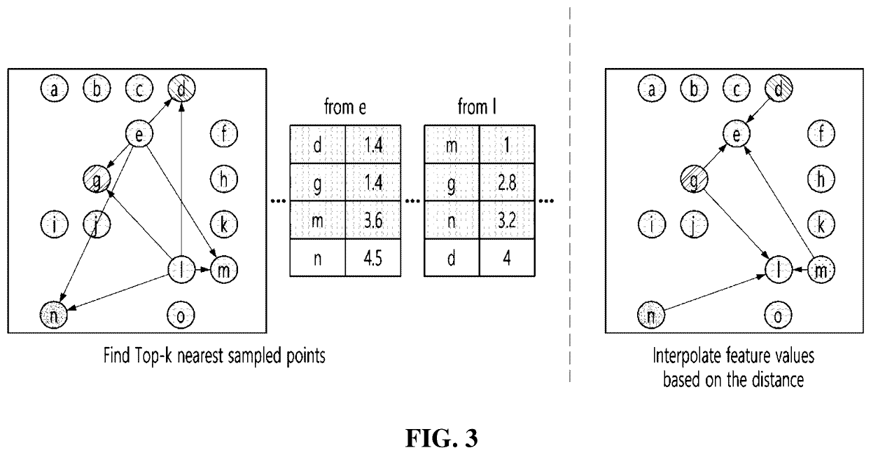

FIG. 3 illustrates interpolation used in a feature propagation process of PointNet++.

The interpolation is an algorithm similar to grouping and is a process of expanding previously obtained local information, and after distances from respective points to all sample points are calculated, a certain number of nearby sample points are found, and local information on the sample points is obtained in proportion to the distances.

In this way, farthest point sampling, ball query, and interpolation algorithms all perform calculations of the distances between points and operations of comparing the calculation results. In particular, in the case of farthest point sampling, there is a limit to parallel processing due to data dependency in the process of comparing a distance from the previous sample point with a distance from the immediately selected sample point. In this way, it is known that, due to the amount of operations and data dependency required to perform repetitive operations for each point, more than 50% of the total artificial neural network processing time is taken up when a graphics processing unit (GPU) performs a corresponding algorithm. This means that, as the number of input points increases, a ratio of time required for sampling and grouping also tends to increase, and considering that the dataset representing an actual three-dimensional (3D) region consists of more than 100,000 points, reducing this time is one of the key issue to be solved for point cloud processing.

However, the related art calculates all three-axis distances when calculating distances between respective points, and thus, the present disclosure intends to improve this.

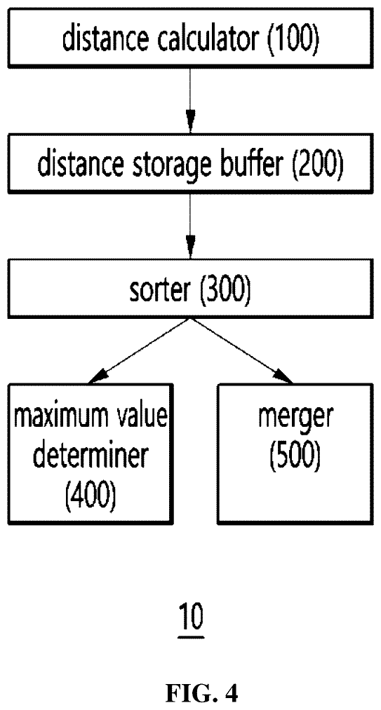

FIG. 4 illustrates a structure of an accelerator that processes a point cloud deep neural network, according to an embodiment of the present disclosure.

An accelerator 10 may include a distance calculator 100, a distance storage buffer 200, a sorter 300, a maximum value determiner 400, and a merger 500. The distance calculator 100 calculates distances between respective points, and in the present disclosure, all three-axis distances are calculated in a first operation mode, and calculations for distances on three axes may be partially omitted in a second operation mode. A specific configuration is described below. The distance storage buffer 200 stores respective distances calculated by the distance calculator 100. The sorter 300 sorts the calculated distance values in order of size. The maximum value determiner 400 determines a farthest point (argmax) among multiple distance values. When the number of distances to be sorted is greater than the maximum input number of the sorter 300, the merger 500 merges some of the results of the sorter 300 and sorts the merged distances. In particular, in an interpolation process, a certain number of maximum values among the total distances has to be obtained through a method, such as k-nearest neighbor (k-NN), but because the sorter 300 may not obtain only the order information on the number obtained by the distance calculator 100, the sorter 300 serves to find a final order by merging the orders obtained multiple times.

The accelerator 10 may perform all three algorithms described above, but the components used for respective algorithms may be different from each other.

First, when performing farthest point sampling, the distance calculator 100 for calculating distances between respective points, the distance storage buffer 200 for storing the calculated distance values for comparing the distances between respective points, the sorter 300 for sorting the distance values so as to be compared with each other, and the maximum value determiner 400 for determining the maximum value argmax among the distance values may be used as described above. In this case, a maximum distance value may be determined by the sorter 300, the maximum distance value may also be determined by the maximum value determiner 400, and results of both the sorter 300 and the maximum value determiner 400 may be used to finally determine the maximum distance value.

Next, when performing a ball query, the distance calculator 100 for calculating distances between respective points and a distance storage buffer 200 for storing the distance values for comparing a critical distance with the distance between respective points or for storing identification information on points located within the critical distance according to the result of comparing the critical distance with the distances between respective points may be used.

Next, when performing interpolation, the distance calculator 100 for calculating distances between respective points, the distance storage buffer 200 for storing respective distance values, the sorter 300 for sorting respective distance values so as to be compared with each other, and the merger 500 for merging orders of respective distance values may be used.

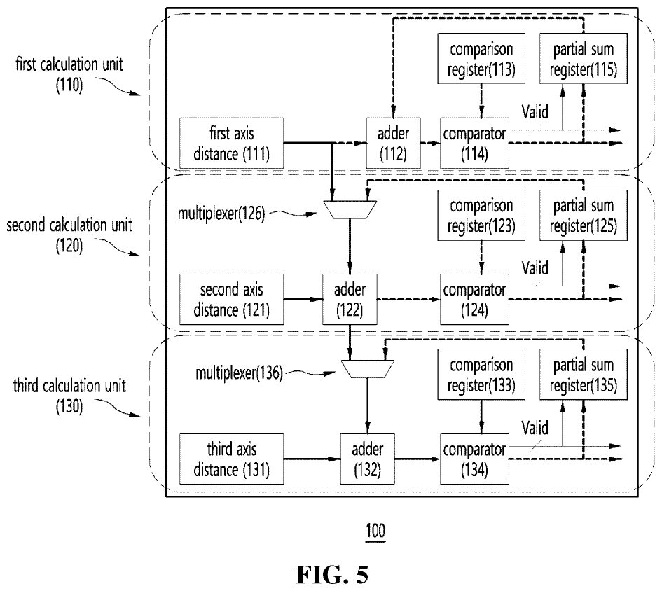

FIG. 5 illustrates a specific configuration of the distance calculator 100 according to an embodiment of the present disclosure.

The distance calculator 100 includes a first calculation unit 110, a second calculation unit 120, and a third calculation unit 130. The distance calculator 100 operates in a first operation mode and a second operation mode, and in the first operation mode, the first calculation unit 110 to the third calculation unit 130 are driven serially, similar to the well-known technology, to calculate a three-dimensional distance between two points. That is, a distance between two points on a first axis may be calculated by the first calculation unit 110, a distance between two points on a second axis may be calculated by the second calculation unit 120, and a distance between two points on a third axis may be calculated by the third calculation unit 130. In this case, the first axis, the second axis, and the third axis may be respectively referred to as the x-axis, the y-axis, and the z-axis, and the order may be changed.

Referring to FIG. 5, a first axis distance 111 of the first calculation unit 110 is transmitted to the second calculation unit 120 through a multiplexer 126, a second axis distance 121 is added to the first axis distance 111 by an adder 122, an output of the second calculation unit 120 is transmitted to the third calculation unit 130 through a multiplexer 136, and an adder 132 add together the first axis distance 111, the second axis distance 121, and a third axis distance 131. In addition, the added three-axis distance is processed as a new distance as described above with reference to FIG. 1, and a comparator 134 compares the new distance with a previous distance stored in a comparison register 133 to determine which value is smaller. The comparator 134 compares the new distance output by the adder 132 with the previous distance stored in the comparison register 133 and stores ae smaller value in the comparison register 133. Then, the comparator 134 stores the smaller value in the distance storage buffer 200 according to a result of the comparison between the new distance and the previous distance, and then sorts the values according to magnitudes by using the sorter 300, and the maximum value determiner 400 determines a maximum value among multiple distances.

In the second operation mode, the first calculation unit 110 to the third calculation unit 130 calculate distances in parallel for different points, thereby increasing operation efficiency, unlike in the first operation mode. That is, in the first operation mode, the first calculation unit 110 to the third calculation unit 130 operate serially to calculate the three-axis distances, while in the second operation mode, the first calculation unit 110 to the third calculation unit 130 calculate one-axis distances of different points in parallel, such that each of the first calculation unit 110 to the third calculation unit 130 calculates a distance between different pairs of points. In addition, each of the first calculation unit 110 to the third calculation unit 130 may omit calculation for some distances on three axes between different pairs of points when a preset condition is satisfied.

To this end, the first calculation unit 110 may include an adder 112, a comparison register 113, a comparator 114, and a partial sum register 115. First, the first calculation unit 110 transmits distances on the first axis between the first point and the second point to the adder 112, and in an initial step, a value stored in the partial sum register 115 is 0, and accordingly, the adder 112 outputs the distance on the first axis as it is, which is transmitted to the comparator 114. In addition, the comparator 114 compares the distance on the first axis with a comparison target distance stored in the comparison register 113, and only when a value output from the adder 112 is less than the comparison target distance, the value is stored in the partial sum register 115. When the value output from the adder 112 is greater than or equal to the comparison target distance, calculations for distances on the other axes are omitted, and the comparison target distance stored in the comparison register 113 is output to the distance storage buffer 200.

In addition, when the distance on the first axis between the first point and the second point is less than the comparison target distance, a distance on the second axis between the first point and the second point is transmitted to the adder 112. In this case, the distance on the first axis that is less than the comparison target distance is stored in the partial sum register 115 in the previous step, the adder 112 outputs the sum of the distance on the first axis and the distance on the second axis. The comparator 114 compares the sum of the distance on the first axis and the distance on the second axis with the comparison target distance, and only when the sum is less than the comparison target distance, the comparator 114 stores the sum in the partial sum register 115. When the sum of the distance on the first axis and the distance on the second axis is greater than or equal to the comparison target distance, calculations for distances on the other axes are omitted, and the comparison target distance stored in the comparison register 113 is output to the distance storage buffer 200.

Finally, when the sum of the distance on the first axis and the distance on the second axis between the first point and the second point is less than the comparison target distance, a distance on the third axis between the first point and the second point is transmitted to the adder 112. In this case, the sum of the distance on the first axis and the distance on the second axis is stored in the partial sum register 115 in the previous step, and accordingly, the adder 112 outputs the sum of the distance on the first axis, the distance on the second axis, and the distance on the third axis. The comparator 114 compares the sum of the distance on the first axis to the distance on the third axis with the comparison target distance, and only when the sum is less than the comparison target distance, the comparator 114 outputs the sum to the distance storage buffer 200. When the sum of the distance on the first to the distance on the third axes is greater than or equal to the comparison target distance, the comparison target distance stored in the comparison register 113 is output to the distance storage buffer 200. For reference, the comparison target distance may be the sum of the distances on the third axis between two points.

Likewise, the second calculation unit 120 may include the adder 122, a comparison register 123, a comparator 124, and a partial sum register 125, and may further include the multiplexer 126. First, unlike the first calculation unit 110, the second calculation unit 120 may transmit distances on the first axis between a third point and a fourth point to the adder 122. The multiplexer 126 selectively transmits an intermediate output of the first calculation unit 110 and an output of the partial sum register 125 to the adder 122, and in the first operation mode, the intermediate output of the first calculation unit 110 is transmitted to the second calculation unit 120, and in the second operation mode, the output of the partial sum register 125 is transmitted to the adder 122. In this case, the intermediate output of the first calculation unit 110 indicates the distance on the first axis between two points calculated by the first calculation unit 110.

The other operations of the second calculation unit 120 are almost the same as the operations of the first calculation unit 110. In the initial step, the adder 122 outputs the distance on the first axis as it is, and the distance is transmitted to the comparator 124. In addition, the comparator 124 compares the distance on the first axis with a comparison target distance stored in the comparison register 123, and only when the value output from the adder 122 is less than the comparison target distance, the value is stored in the partial sum register 125. When the value output from the adder 122 is greater than or equal to the comparison target distance, calculations for distances on the other axes are omitted, and the comparison target distance stored in the comparison register 123 is output to the distance storage buffer 200.

In addition, when the distance on the first axis between the third point and the fourth point is less than the comparison target distance, a distance on the second axis between the third point and the fourth point is transmitted to the adder 122. In this case, the distance on the first axis that is less than the comparison target distance is stored in the partial sum register 125 in the previous step, and accordingly, the adder 122 outputs the sum of the distance on the first axis and the distance on the second axis. The comparator 124 compares the sum of the distance on the first axis and the distance on the second axis with the comparison target distance, and only when the sum is less than the comparison target distance, the sum is stored in the partial sum register 125. When the sum of the distance on the first axis and the distance on the second axis is greater than or equal to the comparison target distance, calculations for distances on the other axes are omitted, and the comparison target distance stored in the comparison register 123 is output to the distance storage buffer 200.

Finally, when the sum of the distance on the first axis and the distance on the second axis between the third point and the fourth point is less than the comparison target distance, the distance on the third axis between the third point and the fourth point is transmitted to the adder 122. In this case, the sum of the distance on the first axis and the distance on the second axis is stored in the partial sum register 125 in the previous step, and accordingly, the adder 122 outputs the sum of the distance on the first axis, the distance on the second axis, and the distance on the third axis. The comparator 124 compares the sum of the distance on the first axis to the distance on the third axis with the comparison target distance, and only when the sum is less than the comparison target distance, the comparator 124 outputs the sum to the distance storage buffer 200. When the sum of the distance on the first axis to the distance on the third axis is greater than or equal to the comparison target distance, the comparison target distance stored in the comparison register 123 is transmitted to the distance storage buffer 200.

Similarly, the third calculation unit 130 includes an adder 132, a comparison register 133, a comparator 134, and a partial sum register 135, and may further include a multiplexer 136. The third calculation unit 130 may transmit distances on the first axis between a fifth point and a sixth point to the adder 132. Because an actual operation of the third calculation unit 130 corresponds to the operation of the second calculation unit 120, detailed descriptions thereof are omitted.

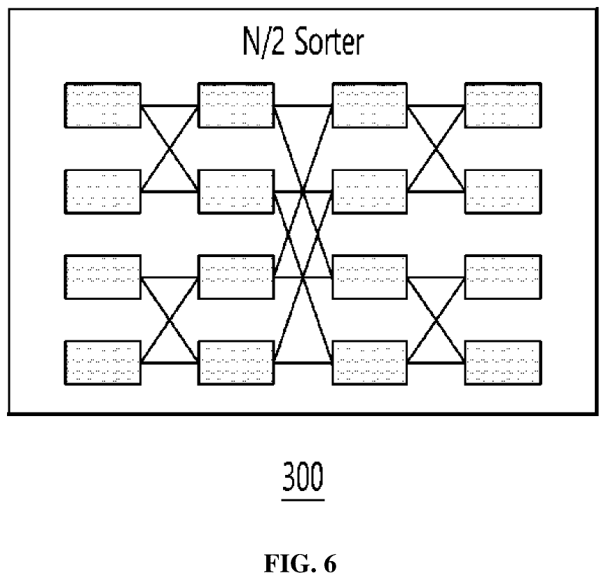

FIG. 6 is a diagram illustrating an internal configuration of the sorter 300 according to the embodiment of the present disclosure.

The sorter 300 sorts respective distance values stored in the distance storage buffer 200 in order of size. In this case, values stored in the distance storage buffer 200 may be respectively classified and stored according to the comparison target unit. For example, as in the farthest point sampling, the distances between the first point and the second point may be classified and stored, and the distances between the second point and the third point may be classified and stored.

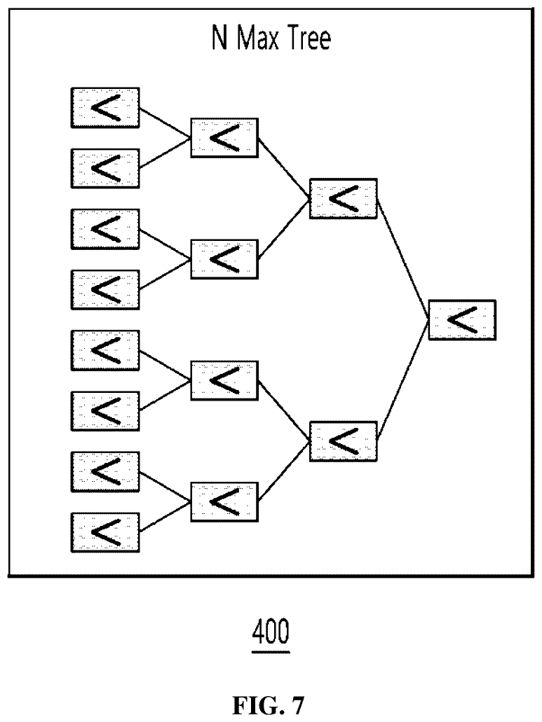

FIG. 7 is a diagram illustrating an internal configuration of the maximum value determiner 400 according to the embodiment of the present disclosure.

Respective distance values received from the distance storage buffer 200 may be compared with each other in a tournament manner according to a tree structure to determine a maximum value. In addition, a maximum distance value determined by using the sorter 300 may be compared with a maximum distance value determined by the maximum value determiner 400.

Details of each individual algorithm are described with reference to drawings below.

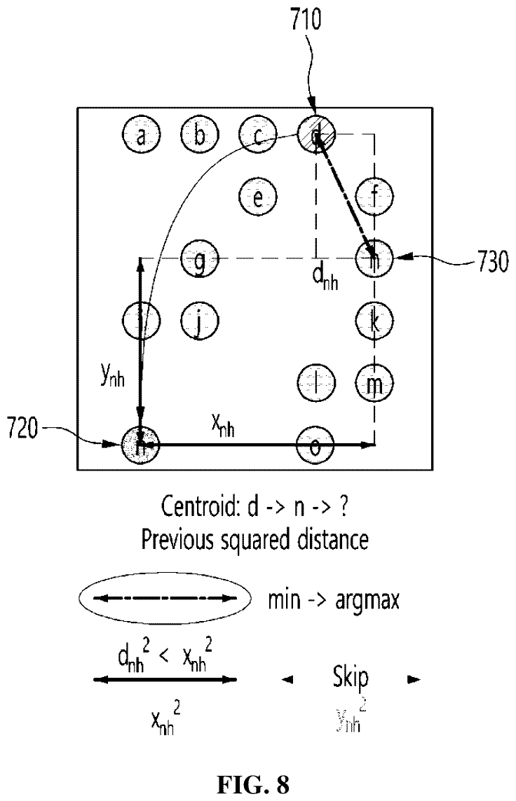

FIG. 8 illustrates a farthest point sampling process according to an embodiment of the present disclosure.

First, in the first round, a second point n or 720, which is a point argmax (a distance from d) that is the farthest from the first point d or 710 randomly selected among multiple points, is selected as a sampling target. In this case, all distances from the first point 710 to the other points are calculated, and a point having the greatest distance among all distances is sampled as a second point 720. In the first round, all distances on the three axis are calculated and added together according to the first operation mode described above, and a point separated the most is selected based thereon. In addition, separation distances for each axis between the first point and candidate points may be stored as initial values in the comparison registers 113, 123, and 133.

In addition, in the second round, in order to sample the third point, distances between the other candidate points and the second point and distances between the candidate points and the first point are calculated for each candidate point and compared with each other, and a candidate point (argmax (min (previous distance, new distance))) having a maximum value among smaller values of the two compared distances is selected as a sampling target for the third point. Therethrough, a third point that is the farthest from the first point and the second point may be selected. To this end, the first calculation unit 110 to the third calculation unit 130 calculate distances in parallel for the second point and other candidate points in the second operation mode. The previous distance indicating a distance between each candidate point calculated in the first round and the first point may be stored in the comparison register 113 as the comparison target distance and reused. In addition, a new distance between the candidate points and the second point is calculated, and the previous distance is compared with the new distance. In this case, in the present disclosure, the first calculation unit 110 to the third calculation unit 130 may not calculate all distances on the three axes according to the comparison result with the comparison target distance, and when the comparison result meets a preset condition, calculations for distances on some axes are omitted.

According to one embodiment, a distance on the first axis between an n point 730 and the second point 720 among the candidates may be preferentially compared with the sum of distances on the three axes between the n point 730 and the first point 710. As illustrated in the example in FIG. 8, when a distance Xdh on the x axis between the n point 730 and the second point 720 is greater than the sum (a comparison target distance) of distances on three axes between the first point 710 and the n point 730 indicating the previous distance, it is certain that distances on three axes between the n point 730 and the second point 720 are greater than distances on three axes between the n point 730 and the first point 710, without the need to further calculate distances on the other axes, and accordingly, by omitting calculation for distances on the second and third axes between the n point 730 and the second point 720, a calculation speed and efficiency may be increased. In this case, the distances between the n point 730 and the first point 710 stored in the comparison register 113 are output to the distance storage buffer 200.

In addition, when the distance on the first axis between the n point 730 and the second point 720 is less than the sum of distances on the three axes between the n point 730 and the first point 710, a corresponding distance is stored in the partial sum register 115, and the distance on the second axis and the distance on the third axis are sequentially calculated, and the sum of the distances is compared with a comparison target distance. That is, the distance on the second axis between the n point 730 and the second point 720 is transmitted to the adder 112, and the adder 112 outputs the sum of the distance on the first axis and the distance on the second axis between the n point 730 and the second point 720 stored in the partial sum register 115 to the comparator 114. The comparator 114 compares the sum of the distance on the first axis and the distance on the second axis with a comparison target distance, and only when the sum is less than the comparison target distance, the comparator 114 stores the sum in the partial sum register 115. When the sum of the distance on the first axis and the distance on the second axis is greater than or equal to the comparison target distance, calculations for distances on the other axes are omitted, and the comparison target distance stored in the comparison register 113 is output to the distance storage buffer 200. Finally, when the sum of the distance on the first axis and the distance on the second axis between the n point 730 and the second point 720 is less than the comparison target distance, the distance on the third axis between the n point 730 and the second point 720 is transmitted to the adder 112. In this case, the sum of the distance on the first axis and the distance on the second axis is stored in the partial sum register 115 in the previous step, and accordingly, the adder 112 outputs the sum of the distance on the first axis, the distance on the second axis, and the distance on the third axis. The comparator 114 compares the sum of the distance on the first axis to the distance on the third axis with the comparison target distance, and only when the sum is less than the comparison target distance, the compactor 114 outputs the sum to the distance storage buffer 200. When the sum of the distance on the first axis to the distance on the third axis is greater than or equal to the comparison target distance, the comparison target distance stored in the comparison register 113 is output to the distance storage buffer 200.

In a subsequent operation, a process of selecting a less value between the previous distance and the new distance among respective points stored in the distance storage buffer 200 and selecting a point with a maximum value as the third candidate by using the sorter 300 or the maximum value determiner 400 is the same as the algorithm of the related art.

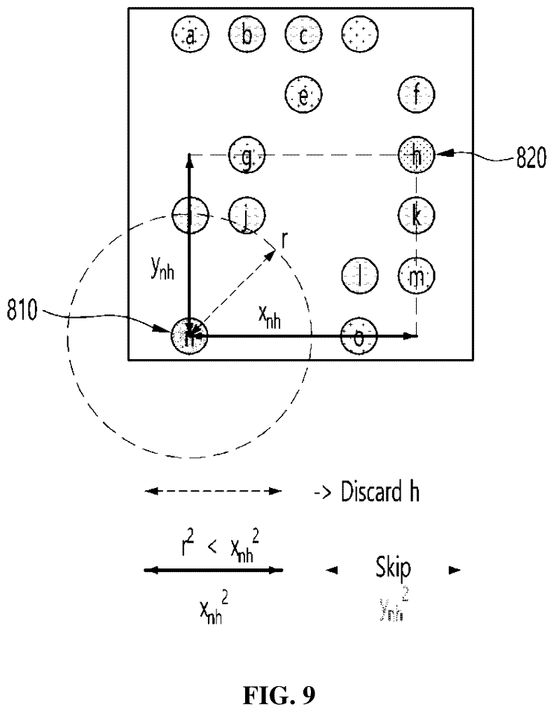

FIG. 9 illustrates a ball query process according to an embodiment of the present disclosure.

In the ball query process, points located within a reference distance r from a first point n or 810 are considered to be neighbors, and the process is repeated until a preset number of neighbors are grouped such that the points located within the reference distance form a group.

In the present disclosure, a distance on one axis is compared with a radius which is a comparison target distance r, and when the distance is greater than or equal to a comparison target distance, a comparison with distances on the other axes is omitted, and thus, a calculation speed and efficiency may be increased. In this case, the comparison target distance may be stored in the comparison registers 113, 123, and 133 of the calculation units 110 to 130.

For example, a distance Xnh on the first axis of a candidate point h or 820 is greater than the comparison target distance r, and accordingly, a comparison with distances on the other axes may be omitted, and a calculation result of the candidate point is not output.

In contrast to this, when the distance on the first axis between the first point 810 which is the center of grouping and the second point 820 in the vicinity is less than a comparison target distance, a corresponding distance is stored in the partial sum register 115, distances on the other axes are sequentially calculated, and the sum of distances on respective axes is compared with the comparison target distance.

For details of the first calculation unit 110 described above, when the distance on the first axis between the first point 810 and the second point 820 is greater than or equal to a comparison target distance, it is certain that distances on three axes between the first point 810 and the second point 820 are greater than the comparison target distance r, and accordingly, calculations for distances on the second and third axes are omitted. In addition, points corresponding thereto are excluded from a grouping target.

In contrast to this, when the distance on the first axis between the first point 810 and the second point 820 is smaller than a comparison target distance, the distance is stored in the partial sum register 115, and distances on the second and third axes are sequentially calculated, and the sum of the distances is compared with the comparison target distance. That is, the distance on the second axis between the first point 810 and the second point 820 is transmitted to the adder 112, and the adder 112 outputs the sum of the distance on the first axis and the distance on the second axis between the first point 810 and the second point 820 stored in the partial sum register 115 to the comparator 114. The comparator 114 compares the sum of the distances on the first and second axes with a comparison target distance, and when the sum is less than the comparison target distance, the sum is stored in the partial sum register 115. When the sum of the distance on the first axis and the distance on the second axis is greater than or equal to the comparison target distance, calculations for distances on the other axes are omitted, and corresponding points are excluded from a grouping target. Finally, when the sum of the distance on the first axis and the distance on the second axis between the first point 810 and the second point 820 is less than the comparison target distance, the distance on the third axis between the first point 810 and the second point 820 is transmitted to the adder 112. In this case, the sum of the distance on the first axis and the distance on the second axis is stored in the partial sum register 115 in the previous step, and accordingly, the adder 112 outputs the sum of the distance on the first axis, the distance on the second axis, and the distance on the third axis. The comparator 114 compares the sum of the distances on the first to third axes with the comparison target distance, and only when the sum is less than or equal to the comparison target distance, the comparator 114 outputs the sum or identification information on a corresponding point to the distance storage buffer 200. When the sum of the distance on the first axis to the distance on the third axis is greater than or equal to the comparison target distance, points corresponding thereto are excluded from a grouping target.

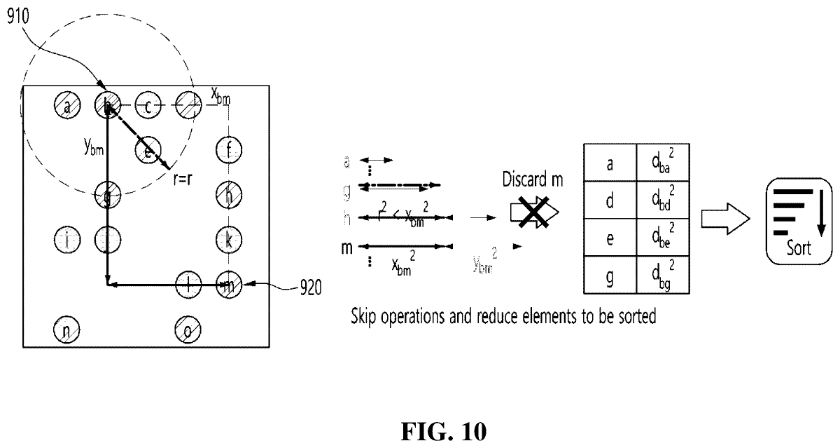

FIG. 10 illustrates an interpolation process according to an embodiment of the present disclosure.

Interpolation is a process of expanding previously obtained local information, and after distances from respective points to all sample points are calculated, a certain number of nearby sample points are found, and local information of corresponding sample points is obtained in proportion to the distances.

In the present disclosure, a distance on one axis between two sampled points is compared with a comparison target distance r, and when the distance on one axis between the two points is greater than the comparison target distance r, comparisons with distances on the other axes are omitted and excluded from an interpolation target, and thus, an operation speed and efficiency may be increased. In this case, the comparison target distance r may be stored in the comparison registers 113, 123, and 133 of the respective calculation units 110, 120, and 130.

For example, a distance Xbm on a first axis of a candidate point m or 920 is greater than the comparison target distance r, and accordingly, comparisons with distances on the other axes may be omitted, and a calculation result of the candidate point is not output.

In contrast to this, when a distance on a first axis between a first point 910 and a second point 920, such as a point e, is less than the comparison target distance r, the distance is stored in the partial sum register 115, distances on the other axes are sequentially calculated, and the sum of distances on respective axes is compared with the comparison target distance.

For details of the first calculation unit 110 described above, when the distance on the first axis between the first point 910 and the second point 920 is greater than or equal to the comparison target distance r, it is certain that distances on three axes between the first point 910 and the second point 920 are greater than the comparison target distance r, and accordingly, calculations for distances on the second and third axes are omitted.

In contrast to this, when the distance on the first axis between the first point 910 and the second point 920 is less than the comparison target distance r, the distance is stored in the partial sum register 115, the distances on the second and third axes are sequentially calculated, and the sum of the distances is compared with the comparison target distance r. That is, the distance on the second axis between the first point 910 and the second point 920 is transmitted to the adder 112, and the adder 112 outputs the sum of the distance on the first axis and the distance on the second axis between the first point 910 and the second point 920 stored in the partial sum register 115 to the comparator 114. The comparator 114 compares the sum of the distances on the first and second axes with the comparison target distance r, and only when the sum is less than the comparison target distance r, the comparator 114 stores the sum in the partial sum register 115. When the sum of the distance on the first axis and the distance on the second axis is greater than or equal to the comparison target distance r, calculations for distances on the other axes are omitted. Finally, when the sum of the distance on the first axis and the distance on the second axis between the first point 910 and the second point 920 is less than the comparison target distance r, a distance on a third axis between the first point 910 and the second point 920 is transmitted to the adder 112. In this case, the sum of the distance on the first axis and the distance on the second axis are stored in the partial sum register 115 in the previous step, and accordingly, the adder 112 outputs the sum of the distance on the first axis, the distance on the second axis, and the distance on the third axis. The comparator 114 compares the sum of the distance on the first axis to the distance on the third axis with the comparison target distance r, and only when the sum is less than the comparison target distance r, the comparator 114 outputs the sum to the distance storage buffer 200. In addition, a certain number of points that are in close distance may be selected by the sorter 300 and the merger 500.

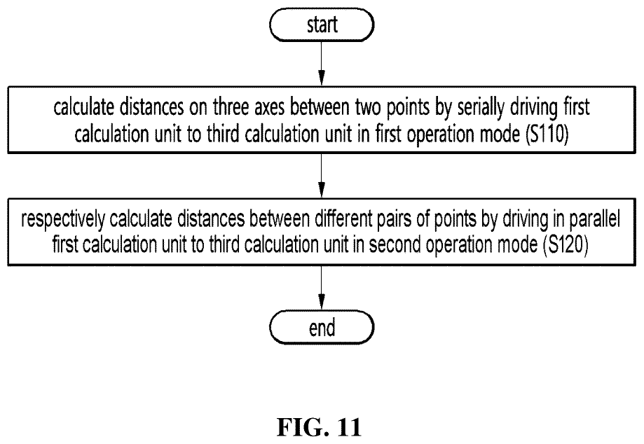

FIG. 11 is a flowchart illustrating an operating method of an accelerator, according to an embodiment of the present disclosure.

First, in a first operation mode, the first calculation unit 110 to the third calculation unit 130 that calculate distances between two points are driven serially to calculate distances between the two points on three axes (S110). That is, the first calculation unit 110 may calculate a distance on a first axis between two points, the second calculation unit 120 may calculate a distance on a second axis between the two points, and the third calculation unit 130 may calculate a distance on a third axis between the two points.

Next, in a second operation mode, the first calculation unit 110 to the third calculation unit 130 are driven in parallel to respectively calculate distances between different pairs of points (S120). In this case, in the second operation mode, the distances on three axes are not calculated in some cases, and calculations for distances may be omitted in some cases.

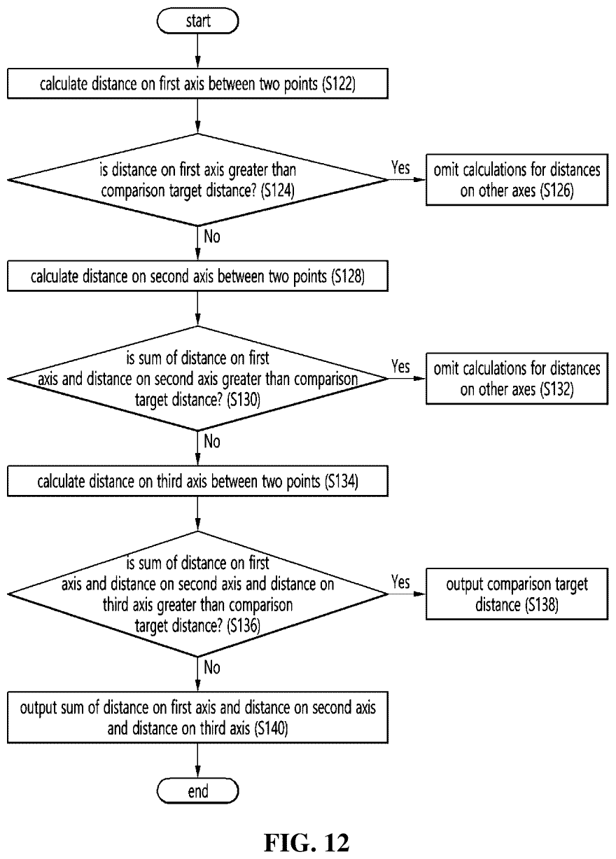

FIG. 12 is a flowchart illustrating a specific process of a second operation mode of an operating method of an accelerator, according to an embodiment of the present disclosure.

First, a distance on a first axis between two points is calculated (S122).

Next, the distance on the first axis is compared with a comparison target distance (S124).

When the distance on the first axis is greater than the comparison target distance, calculations for distances on the other axes are omitted (S126). In addition, when a farthest point sampling algorithm is executed, the comparison target distance is output to the outside. In this case, when a ball query algorithm or an interpolation algorithm is executed, corresponding candidate points are excluded from a grouping target.

In addition, when the distance on the first axis is less than a first comparison target distance, a distance on a second axis is calculated (S128).

Next, the sum of the distance on the first axis and the distance on the second axis is compared with the comparison target distance (S130).

When the sum of the distance on the first axis and the distance on the second axis is greater than or equal to the comparison target distance, calculations for distances on the other axes are omitted (S132). In addition, when the farthest point sampling algorithm is executed, the comparison target distance is output to the outside. When the ball query algorithm or the interpolation algorithm is executed, corresponding candidate points are excluded from a grouping target.

In addition, when the sum of the distance on the first axis and the distance on the second axis is less than the comparison target distance, a distance on a third axis is calculated (S134).

Next, the sum of the distance on the first axis, the distance on the second axis, and the distance on the third axis is compared with the comparison target distance (S136).

When the sum of the distance on the first axis, the distance on the second axis, and the distance on the third axis is greater than or equal to the comparison target distance, the comparison target distance is output to the outside when the farthest point sampling algorithm is executed (S138). In this case, when the ball query algorithm or the interpolation algorithm is executed, corresponding candidate points are excluded from a grouping target.

In addition, when the sum of the distance on the first axis, the distance on the second axis, and the distance on the third axis is less than the comparison target distance, the comparison target distance is output to the outside when the farthest point sampling algorithm is executed (S140). In this case, when the ball query algorithm or the interpolation algorithm is executed, corresponding candidate points are selected as the grouping target.

A method according to an embodiment of the present disclosure may be performed in the form of a recording medium including instructions executable by a computer, such as a program module executed by a computer. A computer readable medium may be any available medium that may be accessed by a computer and includes both volatile and nonvolatile media, removable and non-removable media. Also, the computer readable medium may include a computer storage medium. A computer storage medium includes both volatile and nonvolatile media and removable and non-removable media implemented by any method or technology for storing information, such as computer readable instructions, data structures, program modules or other data.

In addition, although the method and system of the present disclosure are described with respect to specific embodiments, some or all of components or operations thereof may be implemented by using a computer system having a general-purpose hardware architecture.

The above description of the present disclosure is intended to be illustrative, and those skilled in the art will appreciate that the present disclosure may be readily modified in other specific forms without changing the technical idea or essential characteristics of the present disclosure. Therefore, the embodiments described above should be understood as illustrative in all respects and not limiting. For example, each component described in a single type may be implemented in a distributed manner, and likewise, components described in a distributed manner may be implemented in a combined form.

The scope of the present application is indicated by the claims described below rather than the detailed description above, and all changes or modified forms derived from the meaning, scope of the claims, and their equivalent concepts should be interpreted as being included in the scope of the present application.

What is claimed is:

1. An accelerator for processing a point cloud deep neural network, the accelerator comprising:
at least one distance calculator configured to calculate a distance between two points different from each other,
wherein the distance calculator includes a first calculation unit, a second calculation unit, and a third calculation unit, and
the first calculation unit, the second calculation unit, and the third calculation unit are driven serially to calculate distances on three axes between the two points in a first operation mode, and
the first calculation unit, the second calculation unit, and the third calculation unit are driven in parallel to respectively calculate the distances between different pairs of points, in a second operation mode.

2. The accelerator of claim 1, wherein,
in the first operation mode, the first calculation unit calculates a distance on a first axis between the two points, the second calculation unit calculates a distance on a second axis between the two points, and the third calculation unit calculates a distance on a third axis between the two points so as to calculate the distances on the three axes between the two points.

3. The accelerator of claim 1, wherein
in the second operation mode, when a preset condition is satisfied, the first calculation unit, the second calculation unit, and the third calculation unit omit calculations for distances on some of the three axes between the two points.

4. The accelerator of claim 3, wherein,
in the second operation mode,
when the distance on the first axis is greater than or equal to a first comparison target distance, the first calculation unit omits calculations for distances on other axes and outputs the first comparison target distance to the outside, and when the distance on the first axis is less than the first comparison target distance, the first calculation unit calculates the distance on the second axis,
when a sum of the distance on the first axis and the distance on the second axis is greater than or equal to the first comparison target distance, the first calculation unit omits calculations for distances on other axes and outputs the first comparison target distance to the outside, and when the sum of the distance on the first axis and the distance on the second axis is less than the first comparison target distance, the first calculation unit calculates the distance on the third axis, and
when a sum of the distance on the first axis, the distance on the second axis, and the distance on the third axis is greater than or equal to the first comparison target distance, the first calculation unit omits calculations for distances on other axes and outputs the first comparison target distance to the outside, and when the sum of the distance on the first axis, the distance on the second axis, and the distance on the third axis is less than the first comparison target distance, the first calculation unit outputs the sum of the distance on the first axis, the distance on the second axis, and the distance on the third axis.

5. The accelerator of claim 1, wherein
the first calculation unit includes a first adder; a first comparison register storing a first comparison target distance; a first comparator configured to compare an output of the first adder with the first comparison target distance; and a first partial sum register storing the output of the first adder when the output of the first adder is less than the first comparison target distance according to a comparison result of the first comparator,
the second calculation unit includes a second adder; a second comparison register storing a second comparison target distance; a second comparator configured to compare an output of the second adder with the second comparison target distance; a second partial sum register storing the output of the second adder when the output of the second adder is less than the second comparison target distance according to a comparison result of the second comparator; and a first multiplexer configured to selectively output an intermediate output of the first calculation unit and an output of the second partial sum register, and
the third calculation unit includes a third adder; a third comparison register storing a third comparison target distance; a third comparator configured to compare an output of the third adder with the third comparison target distance; a third partial sum register storing the output of the third adder when the output of the third adder is less than the third comparison target distance according to a comparison result of the third comparator; and a second multiplexer configured to selectively output the output of the second adder of the second calculation unit and an output of the third partial sum register.

6. The accelerator of claim 5, wherein,
in the first operation mode, the first multiplexer outputs the distance on the first axis between the two points which are the intermediate outputs of the first calculation unit, the second multiplexer is selected to output the output of the second adder, and a result of comparing a sum of the distance on the first axis output by the first calculation unit, and the distance on the second axis output by the second calculation unit, and the distance on the third axis output by the third calculation unit with a comparison target distance is output.

7. The accelerator of claim 5, wherein,
in the second operation mode,
the first multiplexer is selected to output the output of the second partial sum register, and the second multiplexer is selected to output the output of the third partial sum register,
when a distance on a first axis between a first point and a second point is greater than or equal to the first comparison target distance, the first calculation unit outputs the first comparison target distance to the outside, and when the distance on the first axis between the first point and the second point is less than the first comparison target distance, the distance on the first axis between the first point and the second point is stored in the first partial sum register,
when a sum of the distance on the first axis and a distance on a second axis between the first point and the second point is greater than or equal to the first comparison target distance, the first calculation unit outputs the first comparison target distance to the outside, and when the sum of the distance on the first axis and the distance on the second axis between the first point and the second point is less than the first comparison target distance, the sum of the distance on the first axis and the distance on the second axis between the first point and the second point is stored in the first partial sum register, and
when a sum of the distance on the first axis and the distance on the second axis and a distance on a third axis between the first point and the second point is greater than or equal to the first comparison target distance, the first calculation unit outputs the first comparison target distance to the outside, and when the sum of the distance on the first axis and the distance on the second axis and the distance on the third axis between the first point and the second point is less than the first comparison target distance, the sum of the distance on the first axis and the distance on the second axis and the distance on the third axis is output to the outside.

8. The accelerator of claim 5, wherein,
in the second operation mode,
the first multiplexer is selected to output the output of the second partial sum register, and the second multiplexer is selected to output the output of the third partial sum register,
when a distance on a first axis between a second point and a third point is greater than or equal to the second comparison target distance, the second calculation unit outputs the second comparison target distance to the outside, and when the distance on the first axis between the second point and the third point is less than the second comparison target distance, the distance on the first axis between the second point and the third point is stored in the second partial sum register,
when a sum of the distance on the first axis and a distance on a second axis between the second point and the third point is greater than or equal to the second comparison target distance, the second calculation unit outputs the second comparison target distance to the outside, and when the sum of the distance on the first axis and the distance on the second axis between the second point and the third point is less than the second comparison target distance, the sum of the distance on the first axis and the distance on the second axis between the second point and the third point is stored in the second partial sum register, and
when a sum of the distance on the first axis and the distance on the second axis and a distance on a third axis between the second point and the third point is greater than or equal to the second comparison target distance, the second calculation unit outputs the second comparison target distance to the outside, and when the sum of the distance on the first axis and the distance on the second axis and the distance on the third axis between the second point and the third point is less than the second comparison target distance, the sum of the distance on the first axis and the distance on the second axis and the distance on the third axis is output to the outside.

9. The accelerator of claim 1, further comprising:
a distance storage buffer storing a distance value output by the distance calculator;
a sorter configured to sort distance values stored in the distance storage buffer; and
a maximum value determiner configured to determine a maximum value among the distance values stored in the distance storage buffer,
wherein the distance calculator, the distance storage buffer, the sorter, and the maximum value determiner are used to perform a farthest point sampling algorithm for processing a point cloud,
in a first step, distances from a first point to other points are calculated according to the first operation mode of the distance calculator, are stored in the distance storage buffer, and are sorted by the sorter, and a second point that is the farthest from the first point is selected by the maximum value determiner, and
in a second step, distances between candidate points and the second point and distances between the candidate points and the first point are calculated according to the second operation mode of the distance calculator and are compared with each other, and less distances among compared distances are stored in the distance storage buffer, the distances are sorted by the sorter, and a third point that is farthest from the first point and the second point is selected by the maximum value determiner.

10. The accelerator of claim 9, wherein,
in the first step, the distance calculator stores a distance on a first axis between the first point and another point as a first comparison target distance in the first partial sum register, and
in the second step,
when a distance on a first axis between the candidate point and the second point is greater than or equal to the first comparison target distance, the distance calculator omits a calculation for distances on other axes and outputs the first comparison target distance to the outside, and when the distance on the first axis between the candidate point and the second point is less than the first comparison target distance, the distance on the first axis between the candidate point and the second point is stored in the first partial sum register, and the distance calculator calculates a distance on a second axis between the candidate point and the second point,
when a sum of the distance on the first axis and the distances on the second axis between the candidate point and the second point is greater than or equal to the first comparison target distance, the distance calculator omits calculations for distances on other axes and outputs the first comparison target distance to the outside, and when the sum of the distance on the first axis and the distance on the second axis between the candidate point and the second point is less than the first comparison target distance, the sum of the distance on the first axis and the distance on the second axis between the candidate point and the second point is stored in the first partial sum register, and the distance calculator calculates a distance on a third axis between the candidate point and the second point, and
when a sum of the distance on the first axis and the distance on the second axis and the distance on the third axis between the candidate point and the second point is greater than or equal to the first comparison target distance, the distance calculator outputs the first comparison target distance to the outside, and when the sum of the distance on the first axis and the distance on the second axis and the distance on the third axis between the candidate point and the second point is less than the first comparison target distance, the sum of the distance on the first axis and the distance on the second axis and the distance on the third axis between the candidate point and the second point is output to the outside.

11. The accelerator of claim 1, further comprising:
a distance storage buffer storing a distance value output by the distance calculator,
wherein the distance calculator and the distance storage buffer are used to perform a ball query algorithm for processing a point cloud,
distances from a first point to other points are calculated by the distance calculator, and identification information of points having calculated distances within a critical distance is stored in the distance storage buffer, and
the points having the calculated distances within the critical distance are grouped by a critical number.

12. The accelerator of claim 11, wherein
when a distance on a first axis between the first point and the candidate point is greater than or equal to a comparison target distance, the distance calculator excludes the candidate point from a grouping target for the first point, and when the distance on the first axis between the first point and the candidate point is less than the comparison target distance, the distance calculator stores, in the first partial sum register, the distance on the first axis between the first point and the candidate point, and calculates a distance on a second axis between the first point and the candidate point,
when a sum of the distance on the first axis and the distance on the second axis between the first point and the candidate point is greater than or equal to the comparison target distance, the distance calculator excludes the candidate point from the grouping target for the first point, and when the sum of the distance on the first axis and the distance on the second axis between the first point and the candidate point is less than the comparison target distance, the distance calculator stores, in the first partial sum register, the sum of the distance on the first axis and the distance on the second axis between the first point and the candidate point and calculates a distance on a third axis between the first axis and the candidate point, and
when a sum of the distance on the first axis and the distance on the second axis and the distance on the third axis between the first point and the candidate point is greater than or equal to the comparison target distance, the distance calculator excludes the candidate point from the grouping target for the first point, and when the sum of the distance on the first axis and the distance on the second axis and the distance on the third axis between the first point and the candidate point is less than the comparison target distance, the distance calculator determines the candidate point as the grouping target for the first point.

13. The accelerator of claim 1, further comprising:
a distance storage buffer storing a distance value output by the distance calculator;
a sorter configured to sort distance values stored in the distance storage buffer; and
a merger configured to merge sorted distances,
wherein the distance calculator, the distance storage buffer, the sorter, and the merger are used to perform an interpolation algorithm for processing a point cloud, and
the distance calculator calculates distances from a first point to other points, calculated distances are stored in the distance storage buffer, the calculated distances are sorted by the sorter, and orders of sorted distances are merged by the merger.

14. The accelerator of claim 13, wherein
when a distance on a first axis between the first point and the candidate point is greater than or equal to a comparison target distance, the distance calculator excludes the candidate point from an interpolation target for the first point, and when the distance on the first axis between the first point and the candidate point is less than the comparison target distance, the distance calculator stores, in the first partial sum register, the distance on the first axis between the first point and the candidate point, and calculates a distance on a second axis between the first point and the candidate point,
when a sum of the distance on the first axis and the distance on the second axis between the first point and the candidate point is greater than or equal to the comparison target distance, the distance calculator excludes the candidate point from the interpolation target for the first point, and when the sum of the distance on the first axis and the distance on the second axis between the first point and the candidate point is less than the comparison target distance, the distance calculator stores, in the first partial sum register, the sum of the distance on the first axis and the distance on the second axis between the first point and the candidate point and calculates a distance on a third axis between the first axis and the candidate point, and
when a sum of the distance on the first axis and the distance on the second axis and the distance on the third axis between the first point and the candidate point is greater than or equal to the comparison target distance, the distance calculator excludes the candidate point from the interpolation target for the first point, and when the sum of the distance on the first axis and the distance on the second axis and the distance on the third axis between the first point and the candidate point is less than the comparison target distance, the distance calculator determines the candidate point as the interpolation target for the first point.

15. An operating method of an accelerator for processing a point cloud deep neural network, the operating method comprising:
calculating distances on three axes between two points by serially driving a first calculation unit, a second calculation unit, and a third calculation unit for calculating distances between two points in a first operation mode; and
respectively calculating the distances between different pairs of points by driving in parallel the first calculation unit, the second calculation unit, and the third calculation unit in a second operation mode.

16. The operating method of claim 15, wherein
in the calculating distances on three axes between the two points,
the first calculation unit calculates a distance on a first axis between the two points, the second calculation unit calculates a distance on a second axis between the two points, and the third calculation unit calculates a distance on a third axis between the two points so as to calculate the distances on the three axes between the two points.

17. The operating method of claim 15, wherein the calculating the distances between different pairs of points includes:
calculating, by the first calculation unit, a distance on a first axis;
omitting calculations for distances on other axes and outputting the first comparison target distance to the outside when the distance on the first axis is greater than or equal to a first comparison target distance;
calculating a distance on a second axis when the distance on the first axis is less than the first comparison target distance;
omitting calculations for distances on other axes and outputting the first comparison target distance to the outside when a sum of the distance on the first axis and the distance on the second axis is greater than or equal to the first comparison target distance;
calculating a distance on a third axis when the sum of the distance on the first axis and the distance on the second axis is less than the first comparison target distance;
omitting calculations for distances on other axes and outputting the first comparison target distance to the outside when a sum of the distance on the first axis and the distance on the second axis and the distance on the third axis is greater than or equal to the first comparison target distance; and
outputting the sum of the distance on the first axis and the distance on the second axis and the distance on the third axis to the outside when the sum of the distance on the first axis and the distance on the second axis and the distance on the third axis is less than the first comparison target distance.

18. The operating method of claim 16, wherein
when performing a farthest point sampling algorithm for processing a point cloud,
in a first step, distances from a first point to another point are calculated according to the calculating distances on three axes between the two points, and a second point that is the farthest from the first point is selected based on magnitudes of calculated distances, and
in a second step, distances between candidate points and the second point are compared with distances between the candidate points and the first point according to the calculating the distances between different pairs of points, smaller distances among compared distances are stored, and a third point that is the farthest from the first point and the second point is selected based on magnitudes of stored distances, and
the second step includes:
omitting calculations for distances on other axes and outputting a first comparison target distance to the outside when a distance on a first axis between the candidate point and the second point is greater than or equal to the first comparison target distance set as the distance between the candidate point and the first point;
calculating a distance on a second axis when the distance on the first axis between the candidate point and the second point is less than the first comparison target distance;
omitting calculations for distances on other axes and outputting the first comparison target distance to the outside when a sum of the distance on the first axis and the distance on the second axis between the candidate point and the second point is greater than or equal to the first comparison target distance;
calculating a distance on a third axis when the sum of the distance on the first axis and the distances on the second axis between the candidate point and the second point is less than the first comparison target distance;
omitting calculations for distances on other axes and outputting the first comparison target distance to the outside when a sum of the distance on the first axis and the distance on the second axis and the distance on the third axis between the candidate point and the second point is less than the first comparison target distance; and
outputting the sum of the distance on the first axis and the distance on the second axis and the distance on the third axis between the candidate point and the second point to the outside when the sum of the distance on the first axis and the distance on the second axis and the distance on the third axis is less than the first comparison target distance.

19. The operating method of claim 16, further comprising:
calculating distances from a first point to other points according to the driving in parallel of the first calculation unit and the second calculation unit and the third calculation unit, when executing a ball query algorithm for processing a point cloud, and grouping, by a critical number, points having the distances from the first point to the other points within a critical distance;
excluding a candidate point from a grouping target for the first point when a distance on a first axis between the first point and the candidate point is greater than or equal to a comparison target distance;
calculating a distance on a second axis between the first point and the candidate point when the distance on the first axis between the first point and the candidate point is less than the comparison target distance;
excluding the candidate point from the grouping target for the first point when a sum of the distance on the first axis and the distance on the second axis between the first point and the candidate point is greater than or equal to the comparison target distance;
calculating a distance on a third axis between the first point and the candidate point when the sum of the distance on the first axis and the distance on the second axis between the first point and the candidate point is less than the comparison target distance;
excluding the candidate point from the grouping target for the first point when a sum of the distance on the first axis and the distance on the second axis and the distances on the third axis between the first point and the candidate point is greater than or equal to the comparison target distance; and
determining the candidate point as the grouping target for the first point when the sum of the distance on the first axis and the distance on the second axis and the distance on the third axis between the first point and the candidate point is less than the comparison target distance.

20. The operating method of claim 16, further comprising:
calculating distances from a first point to other points according to the driving in parallel of the first calculation unit and the second calculation unit and the third calculation unit, when executing an interpolation algorithm for processing a point cloud;
excluding a candidate point from an interpolation target for the first point when a distance on a first axis between the first point and the candidate point is greater than or equal to a comparison target distance;
calculating a distance on a second axis between the first point and the candidate point when the distance on the first axis between the first point and the candidate point is less than the comparison target distance;
excluding the candidate point from the interpolation target for the first point when a sum of the distance on the first axis and the distance on the second axis between the first point and the candidate point is greater than or equal to the comparison target distance;
calculating a distance on a third axis between the first point and the candidate point when the sum of the distance on the first axis and the distance on the second axis between the first point and the candidate point is less than the comparison target distance;
excluding the candidate point from the interpolation target for the first point when a sum of the distance on the first axis and the distance on the second axis and the distances on the third axis between the first point and the candidate point is greater than or equal to the comparison target distance; and
determining the candidate point as the interpolation target for the first point when the sum of the distance on the first axis and the distance on the second axis and the distance on the third axis between the first point and the candidate point is less than the comparison target distance.

21. A non-transitory recording medium in which a computer program for performing the operating method according to any one of claim 15 is recorded.
